(19) United States
(12) Patent Application Publication
(10) Pub. No.: US 2009/0101081 A1
(43) Pub. Date: Apr. 23, 2009

(54) Multiple Stanchion Headlock Arrangement with Ear Guards

(75) Inventors: Joseph R. Moreau, Clinton, NY (US); Derrick Fedor, Rome, NY (US)

Correspondence Address: BERNHARD P. MOLLDREM, JR., 224 HARRISON STREET, SUITE 200, SYRACUSE, NY, 13202, US

(73) Assignee: Norbco, Inc.

(21) Appl. No.: 11/874,397

(22) Filed: Oct. 18, 2007

(51) Int. Cl. A01K 15/04

(52) U.S. Cl. 119/739

(57) ABSTRACT

A headlock stanchion panel has latch and release mechanism situated along the top rail for each release stanchion, and is adapted for individual or gang release. There are a pair of release latches each having a tongue that engages a latch member that extends from the end of the release latch. The latch members are mounted on the outsides of respective latch supports, and pivot on bushings. Finger lift members on the pivot latches facilitate individual release. Ear guards are provided to block access from the head side of the top rail to the pivot latches to prevent self-release of the cows.

### BACKGROUND OF THE INVENTION

This invention relates in general to cattle stalls of the type with an automatic headlock for holding the cows in place for milking, feeding, or application of veterinary treatment, and especially to such devices which are self-latching, and which can be released individually or as a group. The invention is more particularly concerned with a latch and release cattle stanchion assembly which facilitates individual release of the cows, whether in a standing or downed position. The invention is also concerned with a mechanism for preventing the cow from releasing herself from the stall, but which facilitates individual release by hand actuation for a given stall.

Headlock or self-latching stanchions have been employed in many varieties. However, it has always been a challenge to provide a headlock arrangement which is self latching when the cow enters a stall position and inserts her head through the stanchions, but also provides both for group release, i.e., by rotating or displacing a release bar or lever, and also permits individual release of a given cow by manipulating a latch device on for a specific cow position. Prior designs have been difficult to actuate by hand, and often carry the risk of pinching the operator's fingers when the movable release stanchion swings to the open position. We have recently discovered that individual cows can release themselves by manipulating the release latches with their ears to allow the release stanchion to swing to an open position. No one has previously identified this as the means for cows self-releasing from these headlock stalls.

### OBJECTS AND SUMMARY OF THE INVENTION

Accordingly, it is an object of this invention to provide a headlock cattle stanchion arrangement that overcomes the drawbacks of the prior art.

It is another object to provide a latching mechanism for a head lock cattle stanchion arrangement, which permits either group or individual release, as well as self-locking, without risk of pinch to the operator and which the individual cow cannot manipulate on her own.

In accordance with an aspect of the present invention, a multiple stanchion headlock panel or assembly is generally based on a frame formed of a horizontal base rail and a horizontal top rail. A set of vertical braces extend between the top and base rails at predetermined intervals, and a corresponding number of fixed stanchions extend vertically between the top and base rails at a predetermined spacing from the associated ones of said vertical braces. These define cow positions. For each cow position there is a support member affixed onto the respective vertical brace; and a vertical release stanchion, i.e., a swing arm, pivotally supported on the support member substantially midway between the brace and the fixed stanchion. The release stanchion has a latch member that projects from the upper end of the release stanchion, so that the latch member projects above the top rail. A latch and release mechanism releasably holds the vertical release stanchion in a vertical position. The latch and release mechanism includes at least one pivot latch that is pivotally supported on a pivot support member over said top rail and has a tongue extending to one side. The tongue is normally in a lowered position to engage the latch member of the release stanchion, and can be lifted to a raised position, either by hand for individual release, or by means of the actuator bar for group release. In the raised position the tongue is out of engagement with the latch member, and this permits the release stanchion to pivot to a tilted position. This widens the gap around the cow's neck so she can withdraw her head from between the fixed stanchion and the release stanchion. Preferably, an ear guard member, e.g., a flap or plate, is positioned at one lateral side of the one pivot latch(es) above said top rail to block access to said pivot latch from said one lateral side. This prevents the cow from self-releasing by lifting the tongue of the pivot latch with her ears.

In the preferred embodiment, each latch and release mechanism includes two pivot latches, to permit the release stanchion to move to one direction for release of a cow in a normal, standing position, or to the other direction to release the cow when she is in the down position. There are left and right pivot latches pivotally supported on respective left and right support members on formed or attached onto the top rail. Each pivot latch has a tongue that engages a respective side of the latch member of said release stanchion. In that case, the ear guard member can be formed as a flat plate member that extends between the left and right support members along one side of the left and right pivot latches. The ear guard member should be installed on the head side of the top rail.

The pivot latch(es) of the latch and release mechanism have a pivot portion that is pivotally supported on the respective pivot support member over said top rail, with its tongue member extending from the pivot portion. The pivot portion that has lateral sides that extend over outer sides of the associated pivot support member. There are first and second bushings on which the pivot member is journaled to serve as a pivot axis. The lateral sides of the pivot latch having openings through which these bushings pass. A bolt or other fastener member passes through said bushings to hold the bushings onto the pivot support member. This provides a more reliable pivot action than simply having the pivot latch journaled on the shaft of a bolt or machine screw. The bushings also serve as spacers, so that the head of the bolt and any nut do not have to contact the sides of the pivot latch, relieving much of the strain on the fastener. This prevents the pivot latch from binding on the pivot support member, even if the bolt is overtightened.

Also, in the design with the pivot latch mounted over the outer sides of the pivot support members, there is less chance for particulates such as feed or sand lodging between the pivot latch member and pivot support member, as well as less chance of finger pinch.

In the preferred embodiment, the pivot latch includes a finger lift member affixed onto an upper side of said tongue for permitting lifting by hand of the tongue to its raised position. This can be in the form of a finger loop welded onto the top surface of the tongue. Each tongue may have an end with a concave portion or recess at a its center thereof with flat portions at sides of concave portion.

A rotatable release actuator bar extends along a top side of said top rail, and has respective offset portions at positions of each said latch and release mechanism. This contacts the concave recess of the tongues when the bar is rotated, and lifts the pivot latches for group release.

The release stanchion pivots to the open position, so the cows may draw their heads back out of the assembly. The release stanchions remain in this open position, and when a next group of cows is brought in, they will each place their head through the opening between the fixed and release stanchions. Then, when the cow lowers her head to feed, she will move the release stanchion, and it will self-lock in the vertical position.

Other mechanisms can be used for group release, such as a cam bar that moves transversely in stead of rotating.

The above and many other objects, features, and advantages of this invention will become apparent from the ensuing detailed description of a preferred embodiment, which should be read in connection with the accompanying Drawing.

### BRIEF DESCRIPTION OF THE DRAWING

FIG. 1 is an elevation of a headlock stanchion panel assembly according to an embodiment of this invention.

FIG. 2 is a detail elevation of the latch and release mechanism of this embodiment.

FIG. 3A is a perspective of a pivot latch, latch support, and latch release bar of this embodiment.

FIG. 3B is another perspective thereof showing the pivot latch lifted for individual release.

FIG. 4 is a perspective of the latch and release mechanism from the distal or head side of the headlock stanchion panel assembly, showing the ear guard feature.

FIG. 5 is another perspective view of the pivot latch and latch support of this embodiment.

FIG. 6 is a further perspective view of the pivot latch and latch support of this embodiment.

FIG. 7 is an elevation of the headlock stanchion panel assembly of this embodiment, showing the release stanchions in the open or release position.

FIG. 8 is a perspective view of a portion of an alternative embodiment.

### DETAILED DESCRIPTION OF THE PREFERRED EMBODIMENT

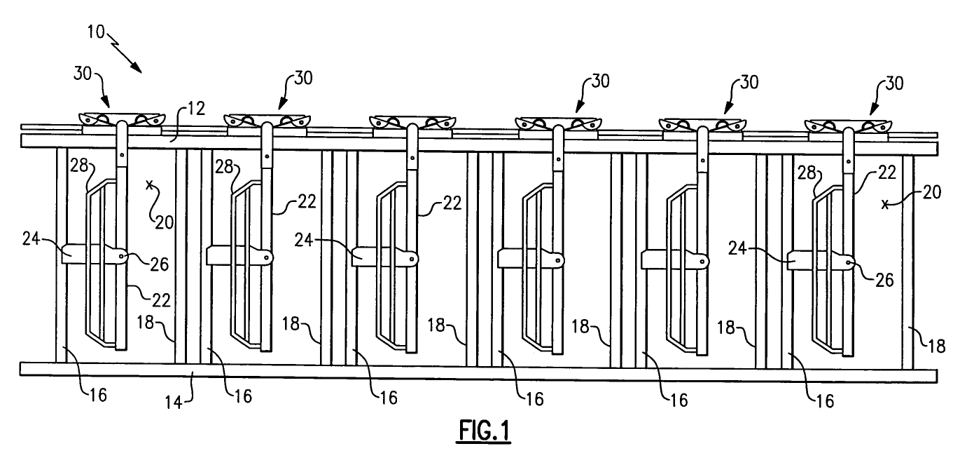

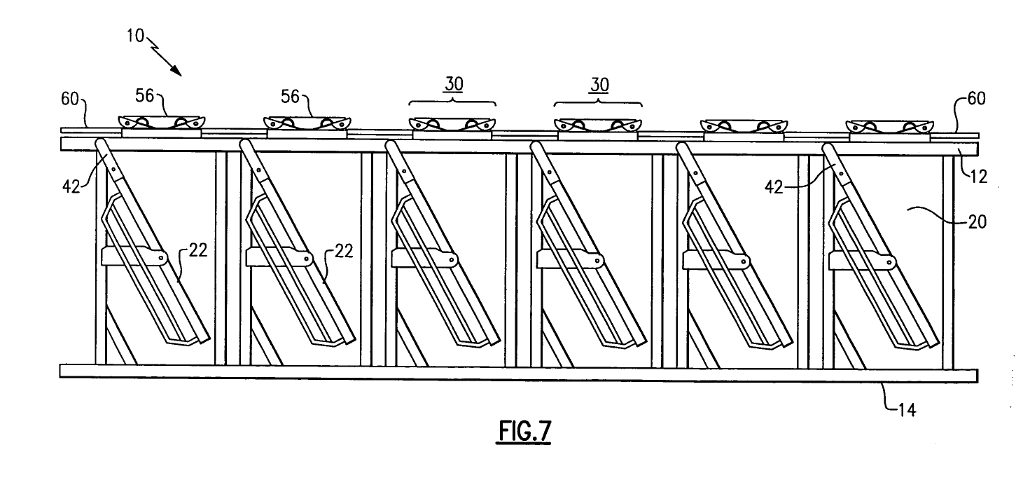

With reference now to the Drawing, and initially to FIG. 1, a headlock panel or headlock assembly 10 may take the form of a frame having a horizontal top rail 12 and a horizontal bottom rail or base rail 14, with a number of vertical brace members 14 that are welded or bolted onto the top and base rails at given intervals that correspond to cow spacings. To the right of each brace member 16 there is a corresponding fixed stanchion 18, also affixed to the top rail and base rail at a given separation from the associated vertical brace member 16. A cow opening 20 is then defined at each cow position between the fixed stanchion 18 and a corresponding release stanchion 22, here shown as a swing arm mounted pivotally at its center. For each release stanchion 22 there is a horizontal pivot bar 24 that is affixed onto the brace member 16, with a pivot member 26 at its free end where the release stanchion 22 is journaled. A guard bar arrangement 28 is affixed onto each of the release stanchion 22 to protect the cow from placing her head on the wrong side of the release stanchion, and also to serve as a pre-weight so that the release stanchion 22 will be biased to open to the left in this embodiment, as illustrated in FIG. 7 when the cows are group-released from the headlock assembly.

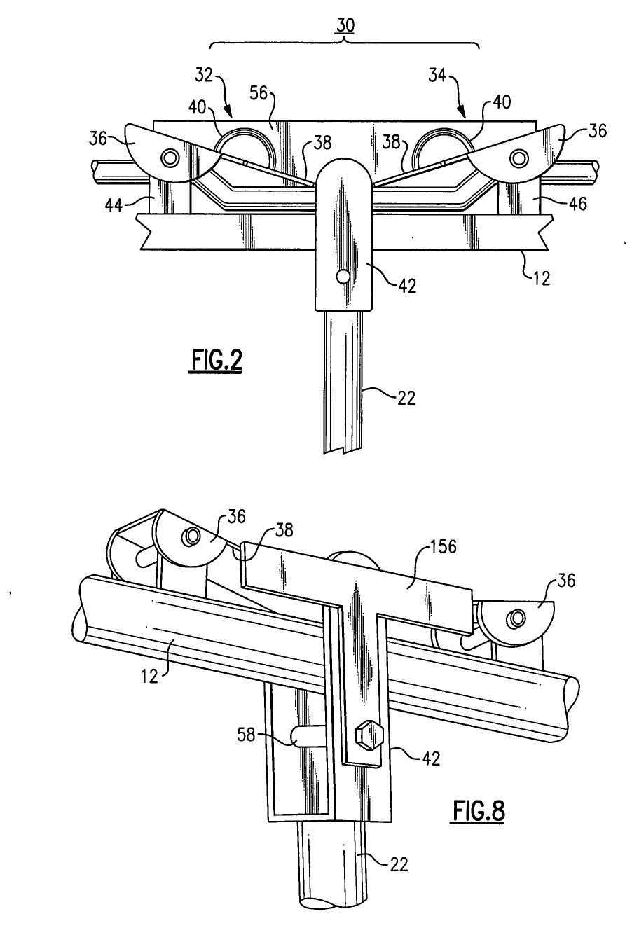

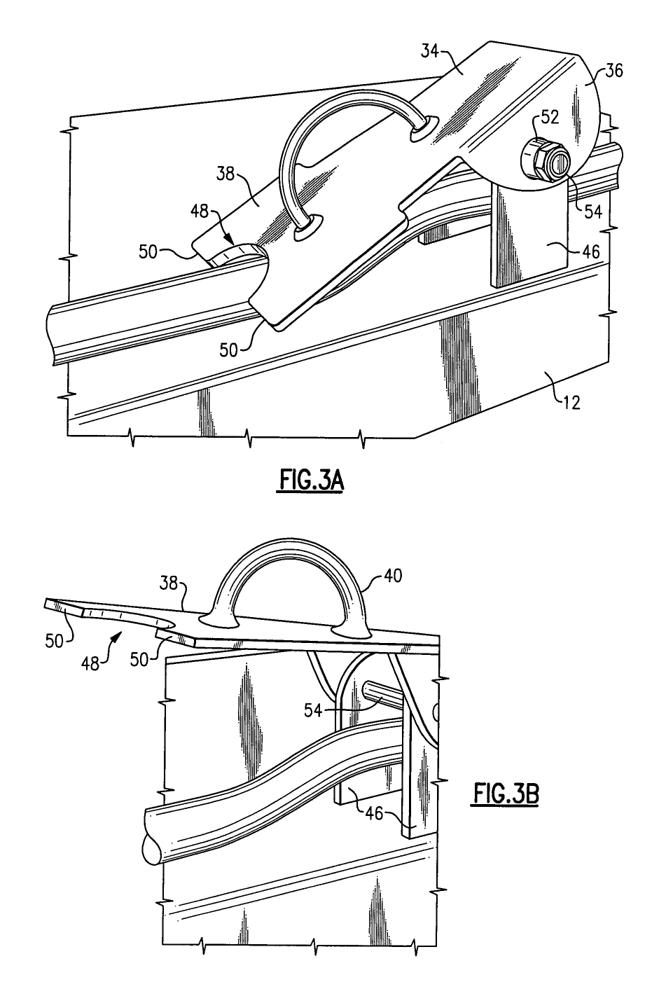

At each cow position, there is a latch and release mechanism 30, details of which are shown in FIG. 2, and in FIGS. 3A, 3B, 4, 5, and 6.

At each cow position, the latch and release mechanism 30 has a left pivot latch 32 and a right pivot latch 34 which self-latch against the release stanchion 22 when it is a vertical orientation, but which can be lifted out of engagement so that the release stanchion can travel to a tilted position. Each pivot latch includes a pivot portion 36, the sides of which are configured in a half-moon shape in this embodiment, with a tongue portion 38 extending out to engage the release stanchion. For each pivot latch 32, 34 a steel loop is welded onto the upper surface to serve as a release handle 30, which allows the operator to lift one or the other of the pivot latches to effect individual release of a cow from the headlock. The release handle 30 allows the operator to pull the tongue portion 38 upward, without danger of pinching his or her fingers.

Latch members 42 are formed at the top end of the release stanchion, and in this embodiment there is a pair of latch members affixed at the top of the release stanchion, so that these latch members 42 project upward at front and back sides of the top rail 12. Here, the latch members 42 are in the form of flat ears with flat sides and a rounded tip.

Each of the pivot latches 32, 34 is mounted on a respective pivot support 44 and 46, which is affixed on the upper surface of the top rail 12, here, welded to the top rail. The outer, half-moon shaped sides of the pivot portions 36 of the pivot latches are disposed at the outer sides of the pivot supports 44, 46.

As shown in FIGS. 3A and 3B, the tongue portion 38 of each of the pivot latches has a concave recess 48 formed at the center part of its end, and has flat portions 50 on either side of this recess. It is the flat portions 50 that contact and engage the ears of the latch members 42.

The pivot portion 36 of each pivot latch is journaled on a pair of steel bushings 52 at each side of the associated pivot support. A fastener, e.g., a machine screw 54 passes through the bushings to attach them to the pivot supports and the pivot members. Each bushing, in the form of a cylindrical nipple, passes through a circular pivot opening in the side of the pivot portion 36. The pivot portion rests on the bushing 52, and not on the shaft of the machine screw 54.

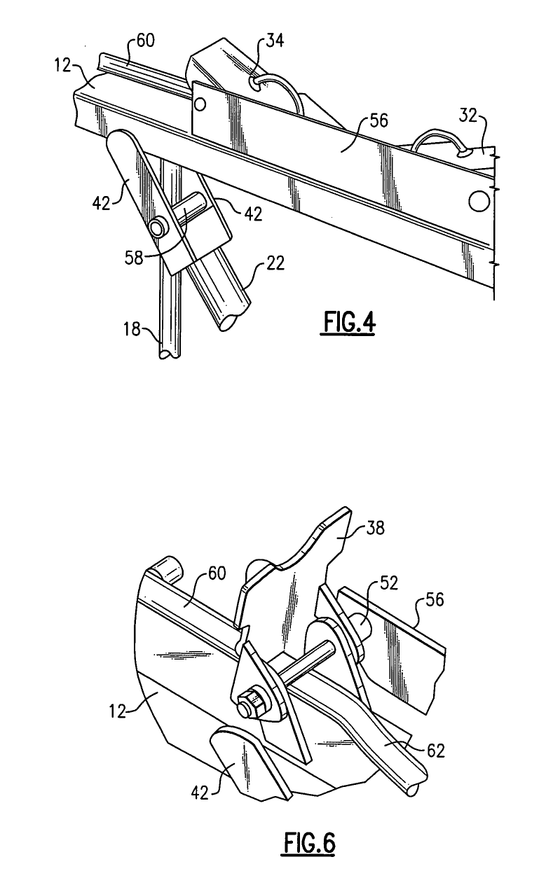

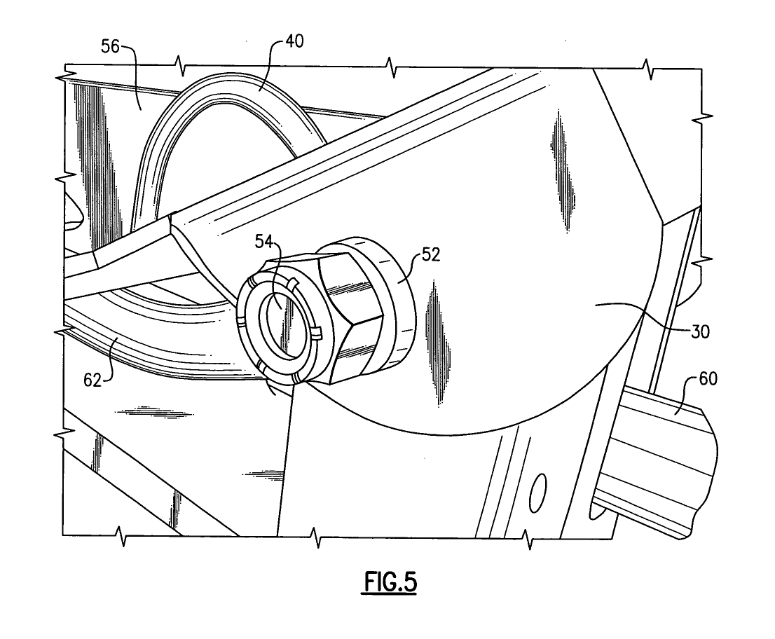

At each cow position, the latch and release mechanism also includes an ear guard 56, seen in FIGS. 4 and 6. The ear guard can be in the form of a steel strip or plate that is secured on the bushings 52 of the pivot latches 32 and 34 at the distal (or head) side of the top rail. The ear guard is spaced out beyond the distal flange of the top rail so as to permit the latch member ear 42 on that side to travel between the top rail 12 and the ear guard 56. The ear guard blocks access to the tongue members 38 of the pivot latches from the distal side. As a practical matter, this prevents the cows from manipulating the pivot latches with their ears and self-releasing.

As also shown in FIG. 4, a bushing 58 may be employed between the two latch member ears 42 at each of the release stanchions 22. This bushing 58 serves as a stop to rest against the brace member 16 (or fixed stanchion 28) when the release stanchion is allowed to swing open to a tilted position.

A release actuator bar 60 extends along the upper side of the top rail 12 and is rotated to effect group release of the cows from the headlock assembly 10. The release bar extends through passages formed in each of the pivot supports 44, 46. There are also rotary supports (not shown) in which the release bar 60 is journaled. At each of the latch and release mechanisms 30, an offset or crank portion 62 is formed in the release bar 60. Normally, the offset portions 62 lie beneath the tongue members 38 of the pivot latches, and allow them to drop to a lowered position where they engage the sides of the latch members 42. When the release bar is rotated, the offset portions rotate upwards, and lift the ends of the tongue members out of engagement with the latch members 42, so that the release stanchion 22 can swing to the open position (e.g., as shown in FIG. 7). This allows the cow neck openings 20 to enlarge at the upper part, so that the cows can withdraw their heads and leave the cow positions.

When a next group of cows enters, they insert their heads through the cow neck openings 20. Then when the cows each lower their heads to feed, that action pushes the release stanchion vertical, where the latch and release mechanism 30 will self-latch.

A cow can be individually released from a given position by the operator lifting up one or the other of the pivot latches 32 or 34. If the cow is standing, the left pivot latch is lifted, so that the release stanchion swings open to the left, widening the neck opening at the top part. However, if the cow is lying, i.e., in a down position, the right pivot latch is lifted so that the release stanchion 22 swings to the right, allowing the neck opening 20 to widen at the lower part, so the cow can withdraw her head from there without first standing up.

FIG. 8 shows the pertinent portions of an alternative embodiment of this invention. Parts of the headlock assembly that are the same as those of the first embodiment are identified with the same reference numbers. Here, the ear guard takes the form of a T-shaped plate member 156 that is affixed onto a portion of the release stanchion on the head side of the rail 12. In this example, the plate member 156 is affixed onto the latch member 42. The side arms of the T-shaped member 156 block the cow's ears from access to the latch tongue members, but do not obstruct individual or gang release. Other embodiments of the cow ear guard are possible besides what is described and illustrated here.

The pivot latches and release mechanisms can take on other shapes and configurations in other embodiments. Ear guards can be of other designs to achieve blocking of access by an animal to the release mechanism. Also, while the invention has been described herein with reference to a some selected preferred embodiments, the invention is not limited to that those embodiments. Rather, many modifications and variations will become apparent to persons skilled in the art without departing from the scope and spirit of this invention, as defined in the appended claims.

I claim:

1. A multiple stanchion headlock panel comprising:
a frame that includes a horizontal top rail, a plurality of vertical braces extending to the top and base rail at predetermined intervals, and a plurality of fixed stanchions extending vertically between the top and base rails at a predetermined spacing from the associated ones of said vertical braces to define cow positions therebetween; and
each said cow position including:
a support member affixed onto the respective vertical brace;
a vertical release stanchion pivotally supported on said support member substantially midway between said brace and said fixed stanchion and having a portion thereof projecting above said top rail;
a latch and release mechanism, for releasably holding the vertical release stanchion in a vertical position; and
an ear guard member positioned at one lateral side of the latch and release mechanism above said top rail to block access to said pivot latch from said one lateral side, to prevent a cow from self-releasing from the cow position.

2. The multiple stanchion headlock panel according to claim 1 wherein said latch and release mechanism includes at least one flapper that self-latches the associated release stanchion, and which can be selectively raised to release the release stanchion.

3. A multiple stanchion headlock panel comprising:
a frame formed of a horizontal base rail and a horizontal top rail, a plurality of vertical braces extending between the top and base rails at predetermined intervals, and a plurality of fixed stanchions extending vertically between the top and base rails at a predetermined spacing from the associated ones of said vertical braces to define cow positions therebetween; and
each said cow position including:
a support member affixed onto the respective vertical brace;
a vertical release stanchion pivotally supported on said support member substantially midway between said brace and said fixed stanchion and having a latch member projecting from an upper end thereof to project above said top rail; and
a latch and release mechanism, for releasably holding the vertical release stanchion in a vertical position, the latch and release mechanism including at least one pivot latch that is pivotally supported on a pivot support member over said top rail, and having a tongue that is normally in a lowered position to engage the latch member of said release stanchion, and can be lifted to a raised position wherein said tongue is out of engagement with the latch member to permit the release stanchion to pivot to a tilted position; and
an ear guard member positioned at one lateral side of the at least one pivot latch above said top rail to block access to said pivot latch from said one lateral side.

4. The multiple stanchion headlock panel according to claim 3 wherein each said latch and release mechanism includes left and right pivot latches pivotally supported on respective left and right support members on said top rail, and each having a tongue engaging a respective side of the latch member of said release stanchion.

5. The multiple stanchion headlock panel according to claim 4 wherein said ear guard member includes a plate member extending between said left and right support members along one side of said left and right pivot latches.

6. The multiple stanchion headlock panel according to claim 3 wherein said ear guard member includes a transverse plate member supported upon one side of said release stanchion.

7. The multiple stanchion headlock panel according to claim 6 wherein said ear guard member is a T-shaped member supported upon the latch member of said release stanchion.

8. A multiple stanchion headlock panel comprising:
a frame formed of a horizontal base rail and a horizontal top rail, a plurality of vertical braces extending between the top and base rails at predetermined intervals, and a plurality of fixed stanchions extending vertically between the top and base rails at a predetermined spacing from the associated ones of said vertical braces to define cow positions therebetween; and
each said cow position including:
a support member affixed onto the respective vertical brace;
a vertical release stanchion pivotally supported on said support member substantially midway between said brace and said fixed stanchion and having a latch member projecting from an upper end thereof to project above said top rail; and
a latch and release mechanism, for releasably holding the vertical release stanchion in a vertical position, the latch and release mechanism including at least one pivot latch that is pivotally supported on a pivot support member over said top rail, and having a tongue that is normally in a lowered position to engage the latch member of said release stanchion, and can be lifted to a raised position wherein said tongue is out of engagement with the latch member to permit the release stanchion to pivot to a tilted position; and
said pivot latch having a pivot portion that has lateral sides that extend over outer sides of the associated pivot support member; and a pivot member is formed of first and second bushings, the lateral sides of the pivot latch having openings through which an associated on of said bushings passes, such that the pivot member is journaled on said bushings; and a fastener member passing through said bushings to hold the bushings onto the pivot support member.

9. The multiple stanchion headlock panel according to claim 8 further comprising an ear guard member attached onto the pivot support portion on one lateral side thereof.

10. The multiple stanchion headlock panel according to claim 8 wherein said pivot latch includes a finger lift member affixed onto an upper side of said tongue for permitting lifting by hand of the tongue to its raised position.

11. The multiple stanchion headlock panel according to claim 8 wherein each said latch and release mechanism includes left and right pivot latches pivotally supported on respective left and right support members on said top rail, and each having a tongue engaging a respective side of the latch member of said release stanchion.

12. The multiple stanchion headlock panel according to claim 11 wherein said ear guard member includes a plate member extending between said left and right support members along one side of said left and right pivot latches.

13. The multiple stanchion headlock panel according to claim 11 wherein said latch member includes a pair of flat ear members extending on respective sides of said top rail.

14. The multiple stanchion headlock panel according to claim 11 wherein each said tongue has an end that is concave at a center thereof with flat portions at side of said concave portion.

15. The multiple stanchion headlock panel according to claim 8 including a rotatable release actuator bar extending along a top side of said top rail, and having respective offset portions at positions of each said latch and release mechanism.
